(19) United States
(12) Patent Application Publication
(10) Pub. No.: US 2014/0180940 A1
(43) Pub. Date: Jun. 26, 2014

(54) Real time product verification by use of NFC technology

(71) Applicant: Jianping He, Edison, NJ (US)

(72) Inventor: Jianping He, Edison, NJ (US)

(21) Appl. No.: 13/723,135

(22) Filed: Dec. 20, 2012

(51) Int. Cl. G06Q 30/00

(52) U.S. Cl. CPC G06Q 30/0185
USPC 705/318

(57) ABSTRACT

The present invention provides a method and system for real time product verification by use of NFC technology. To start product verification, consumers use their NFC-reader-enabled mobile devices to tap the NFC-enabled tags of products or tap products they are interested in. After tapping, the product verification client applications in consumers' NFC-reader-enabled mobile devices will be automatically started, capture, save and process data in the NFC-enabled tags of products, create product verification requests with data in the NFC-enabled tags of products, send product verification requests to product verification servers, receive, save and process responses from product verification servers, and display verification results from responses on the screens of consumers' NFC-reader-enabled mobile devices.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

Counterfeits are fake replicas of real products and can be found in a variety of industries, such as drug, food and wine, electronics, art, apparel and shoe, etc. To pursue high profits, counterfeit producers generally target at expensive products or famous brands, and produce counterfeits with cheaper labors or materials. Some counterfeits in drug, food and wine can be harmful even fatal to human health. It is quite challenging for consumers to tell counterfeits from real products. It is often too late when consumers find out what they have purchased are counterfeits. The question is whether it is possible for consumers to verify products in real time before or after they purchase products.

Near Field Communication (NFC) is a set of international standards for very short-range radio transmission between two devices. It operates on 13.56 MHz frequency and supports data transmission rates ranging from 106 kbps to 424 kbps. NFC-enabled devices can communicate with each other by either tapping each other or holding them close together. During communication, the device that starts NFC is called the initiator, while the other device is called the target. There are two types of communication modes in NFC. One communication mode is called active mode, where both the initiator and the target have their own electromagnetic fields and can communicate with each other by alternating radio signal transmissions. The other communication mode is called passive mode, where the initiator generates radio signals, while the target gets power from initiator generated electromagnetic field and responds to the initiator by modulating that electromagnetic field.

In addition, there are three operating modes for NFC-enabled devices. One operating mode is read/write mode, where NFC-enabled devices can perform read/write operations to other NFC-enabled devices such as NFC-enabled tags. Another operating mode is peer-to-peer mode, where both the initiator and the target can perform read/write operations to each other. The other operating mode is called card emulation mode, where NFC-enabled devices act as contact-less cards.

NFC technology is being used in mobile payment, identification, access token, social networking, etc. There are great potentials for NFC technology to be applied in people's daily lives.

If a product is equipped with a NFC-enabled tag that uniquely identifies the product and is extremely hard to be replicated, and if a NFC-reader-enabled mobile device can communicate with a product verification server, then the NFC-reader-enabled mobile device can be used to verify the authentication of the product in real time.

### BRIEF SUMMARY OF THE INVENTION

The present invention provides a method, system and program product for real time product verification by use of NFC technology. To start NFC, consumers use their NFC-reader-enabled mobile devices to tap the NFC-enabled tags of products they are interested in. The product verification client applications in their NFC-reader-enabled mobile devices capture, save and process data in the NFC-enabled tags of products, create product verification requests, send product verification requests with data in the NFC-enabled tags of products to product verification servers, fetch responses from product verification servers, save responses in their NFC-reader-enabled mobile devices, and display verification results from responses on the screens of their NFC-reader-enabled mobile devices.

### BRIEF DESCRIPTION OF THE SEVERAL VIEWS OF THE DRAWING

FIG. 1 illustrates a schematic architecture of a NFC-reader-enabled mobile device with a product verification client application, in accordance with one embodiment of the present invention.

FIG. 2 illustrates a schematic block diagram of a product, a product verification server, a communication network, and a NFC-reader-enabled mobile device with a product verification client application, in accordance with one embodiment of the present invention.

FIG. 3 illustrates a schematic sequence diagram of steps from NFC-enabled tag data retrieval to product verification, in accordance with one embodiment of the present invention.

### DETAILED DESCRIPTION OF THE INVENTION

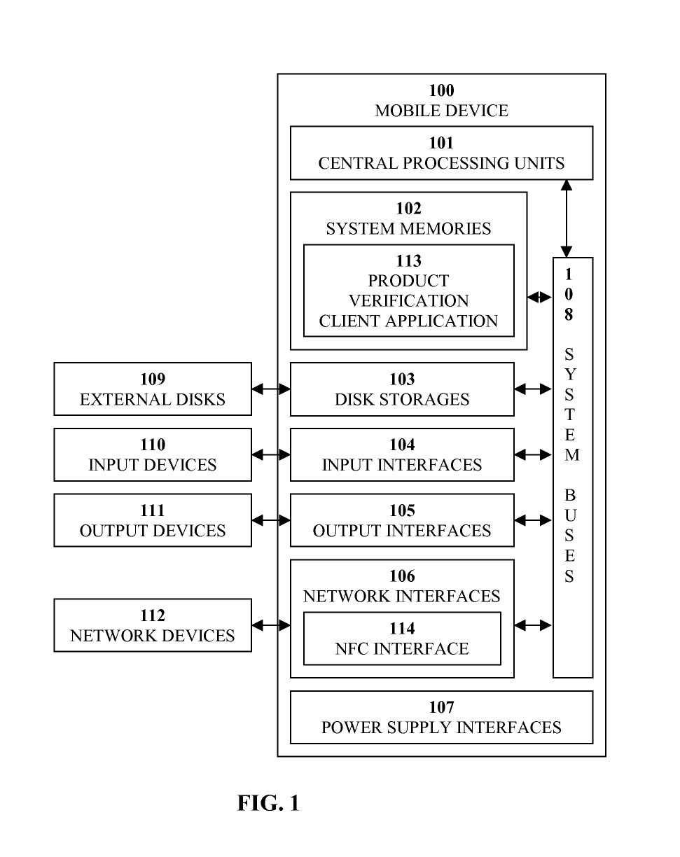

FIG. 1 illustrates a schematic architecture of a NFC-reader-enabled mobile device with a product verification client application. In one embodiment, the NFC-reader-enabled mobile device 100 comprises central processing units 101, system memories 102, disk storages 103, input interfaces 104, output interfaces 105, network interfaces 106, power supply interfaces 107, and system buses 108.

The central processing units 101 provide a means for executing executable programs and can be any types of micro-controllers, processors, micro-processors, or multi-processors. The system memories 102 provide a means for storing executable programs such as a basic input and output system (BIOS), one or more operating systems, a plurality of firmware modules, and a plurality of software or application modules. The system memories 102 can be any combinations of random-access memory and read-only memory. The product verification client application 113 is running in the system memories 102. The disk storages 103 provide a means for storing programs, files and data, and can be any types of internal disks, external disks 109, optical disks, and the like.

The input interfaces 104 provide a means for transferring data into the NFC-reader-enabled mobile device 100 through the input devices 110 such as keyboards, keypads, touchpads, touch screens, thumbwheels, trackballs, styluses, joysticks, microphones, cameras, sensors, etc. The input devices 110 can be internal or external parts of the NFC-reader-enabled mobile device 100. The output interfaces 105 provide a means for transferring data from the NFC-reader-enabled mobile device 100 to the output devices 111 such as screens, displays, televisions, speakers, etc. The output devices 111 can be internal or external parts of the NFC-reader-enabled mobile device 100.

The network interfaces 106 provide a means for transferring data between the NFC-reader-enabled mobile device 100 and other network devices 112 via communication networks (not shown) such as circuit-switched telephone networks or packet-switched data networks. They can be wireless interfaces such as radio interfaces with antennas, transmitters and receivers, wireless local, wide and metro area network interfaces, and may include other wireless, wired and satellite network interfaces. The NFC Interface 114 is a special network interface that can communicate with other NFC-enabled network devices through NFC.

The power supply interfaces 107 provide power to the NFC-reader-enabled mobile device 100. They can be associated with a number of batteries. They may include external power sources such as AC adapters.

The system buses 108 provide a means for transferring data internally among the central processing units 101, the system memories 102, the disk storages 103, the input interfaces 104, the output interfaces 105, the network interfaces 106, and other components (not shown) of the NFC-reader-enabled mobile device 100.

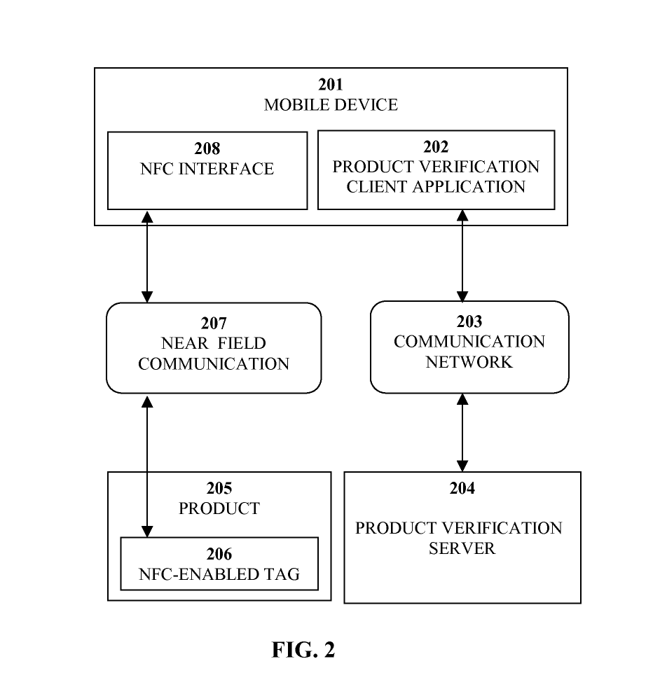

Reference is now to FIG. 2, which illustrates a schematic block diagram of a product, a product verification server, a communication network, and a NFC-reader-enabled mobile device with a product verification client application. In one embodiment, the product verification server 204 maintains internal or external databases of mappings between products and data of NFC-enabled tags. The NFC-reader-enabled mobile device 201 has the same architecture as the one denoted in FIG. 1. The NFC Interface 208 in the NFC-reader-enabled mobile device 201 can read data in the NFC-enabled tag 206 of the product 205 through the NFC 207. The product verification client application 202 in the NFC-reader-enabled mobile device 201 can communicate with the product verification server 204 through the communication network 203 for bi-direction data exchange.

The communication network 203 provides a means for transporting data between network data senders and network data receivers. It comprises wireless networks, zero or more of wired networks and satellite networks. Wireless networks can be one or more of wireless local area networks such as WI-FI, wireless wide area networks, wireless metropolitan area networks such as worldwide interoperability for microwave access, long term evolution networks, cellular networks such as global system for mobile communication, general packet radio service, code division multiple access, digital enhanced cordless telecommunication, integrated digital enhanced network, and the like. Wired networks can be one or more of Internet, intranets, local area networks such as ethernet, wide area networks such as frame relay and asynchronous transfer mode, virtual private networks, public switched telephone networks, and the like.

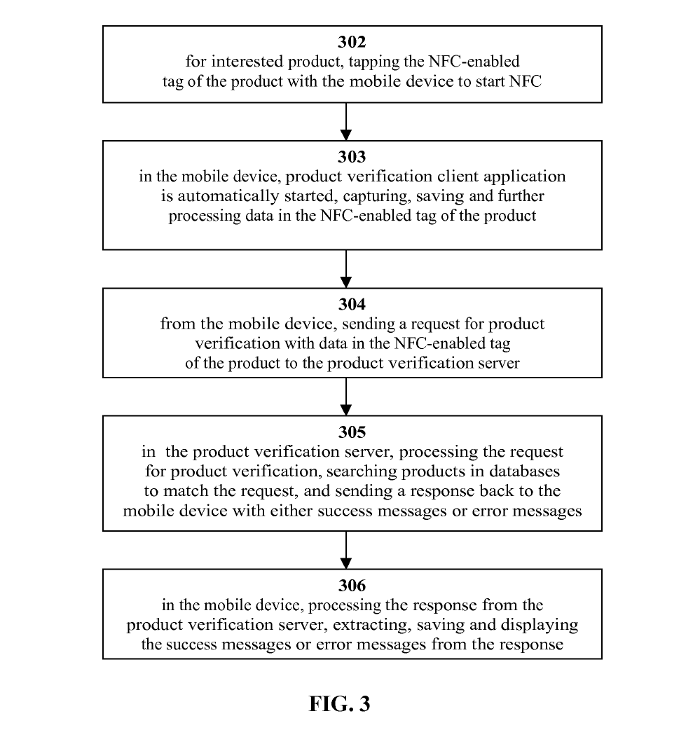

Reference is now to FIG. 3, which illustrates a schematic sequence diagram of steps from NFC-enabled tag data retrieval to product verification, in accordance with one embodiment of the present invention. A consumer finds a particular product he/she is interested in. However the consumer wants to check the authentication of the product before purchase. Assume the product has a NFC-enabled tag that uniquely identifies the product and is extremely hard to be replicated. The consumer starts the product verification client application in his/her NFC-reader-enabled mobile device in step 301. The consumer taps the NFC-enabled tag of the product with his/her NFC-reader-enabled mobile device to start NFC in step 302. The product verification client application captures, saves and processes data in the NFC-enabled tag of the product in step 303. In addition, the product verification client application creates a request for product verification, and sends the request with data in the NFC-enabled tag of the product to the product verification server through a communication network in step 304.

In step 305, the product verification server receives the request for product verification, searches internal or external databases or storages for any matched products associated with the request, and then sends a response back to the NFC-reader-enabled mobile device of the consumer with product verification success messages if there is a match, or product verification error messages if there is no match.

In step 306, the NFC-reader-enabled mobile device of the consumer receives the response from the product verification server through the communication network. The product verification client application in the NFC-reader-enabled mobile device processes the response, extracts, saves and displays product verification success messages or error messages from the response. The consumer can make decision whether to purchase the product after product verification is finished.

While the present invention has been described with respect to a limited number of embodiments, those skilled in the art will appreciate numerous modifications and variations therefrom. It is intended that the appended claims cover all such modifications and variations as fall within the true spirit and scope of the present invention.

1. A method providing real time product verification for a non-vending-machine product with a NFC-enabled tag between a product verification server and a NFC-reader-enabled mobile device with a product verification client application via a communication network, said method comprising the acts:
starting NFC by tapping said tag or said product with said mobile device;
capturing, saving and processing data in said tag by said product verification client application that is automatically started after tapping;
creating a product verification request with said data by said product verification client;
sending said request from said product verification client application to said product verification server through said communication network;
receiving said request in said product verification server;
searching products in said product verification server to match said request;
creating a response with success or error messages for said request by said product verification server;
sending said response from said product verification server to said product verification client application through said communication network;
receiving, saving and processing said response by said product verification client application;
displaying said success or error message from said response on the screen of said mobile device by said product verification client application.

2. The method as claimed in claim 1, wherein said data in said tag of said product contains unique data that can identify said product and can be read-only by said mobile device; wherein said mobile device comprises one or more of central processing units, one or more of system memories where said product verification client application can be running, one or more of NFC interfaces, one or more of other wireless network interfaces, zero or more of wired and satellite network interfaces, one or more of power supply interfaces and/or batteries, one or more of output interfaces and/or output devices including display screens, zero or more of system buses, zero or more of disk storages, zero or more of input interfaces and/or input devices; wherein said communication network comprises one or more of wireless networks, zero or more of wired and satellite networks; wherein said product verification server is associated with databases of mapping between products and data in NFC-enabled tags, is able to search products based on data in NFC-enabled tags, and can respond to said product verification client application with product verification success or error messages after receiving a request with data in said NFC-enabled tag from said product verification client application through said communication network.

3. A system providing real time product verification, said system comprising:
a NFC-reader-enabled mobile device;
a non-vending-machine product with a NFC-enabled tag;
a product verification server;
a communication network; and performing the acts:
starting NFC by tapping said tag or said product with said mobile device;
capturing, saving and processing data in said tag by said product verification client application that is automatically started after tapping;
creating a product verification request with said data by said product verification client;
sending said request from said product verification client application to said product verification server through said communication network;
receiving said request in said product verification server;
searching products in said product verification server to match said request;
creating a response with success or error messages for said request by said product verification server;
sending said response from said product verification server to said product verification client application through said communication network;
receiving, saving and processing said response by said product verification client application;
displaying said success or error messages from said response on the screen of said mobile device by said product verification client application.

4. The system as claimed in claim 3, wherein said data in said tag of said product contains unique data that can identify said product and can be read-only by said mobile device; wherein said mobile device comprises one or more of central processing units, one or more of system memories where said product verification client application can be running, one or more of NFC interfaces, one or more of other wireless network interfaces, zero or more of wired and satellite network interfaces, one or more of power supply interfaces and/or batteries, one or more of output interfaces and/or output devices including display screens, zero or more of system buses, zero or more of disk storages, zero or more of input interfaces and/or input devices; wherein said communication network comprises one or more of wireless networks, zero or more of wired and satellite networks; wherein said product verification server is associated with databases of mapping between products and data in NFC-enabled tags, is able to search products based on data in NFC-enabled tags, and can respond to said product verification client application with product verification success or error messages after receiving a request with data in said NFC-enabled tag from said product verification client application through said communication network.

5. (canceled)

6. (canceled)
